(19) United States
(12) Patent Application Publication
(10) Pub. No.: US 2015/0285475 A1
(43) Pub. Date: Oct. 8, 2015

(54) Pool Light

(71) Applicant: Craig Perkins, Loxahatchee, FL (US)

(72) Inventor: Craig Perkins, Loxahatchee, FL (US)

(21) Appl. No.: 14/676,061

(22) Filed: Apr. 1, 2015

Related U.S. Application Data
(60) Provisional application No. 61/973,963, filed on Apr. 2, 2014.

(51) Int. Cl. F21V 21/06; F21V 21/02; F21V 5/04; F21S 8/00; F21V 31/00; F21V 23/04

(52) U.S. Cl. CPC F21V 21/06; F21V 31/005; F21V 23/04; F21V 5/04; F21S 8/03; F21V 21/02; F21W 2131/401

(57) ABSTRACT

A pool light is provided. The pool light is configured to provide illumination near water or underwater. The pool light includes a base plate having a pair of mounting brackets thereon. A receiver tube is pivotally attached to the pair of mounting brackets, wherein the receiver tube is configured to move along a singular plane. The receiver tube includes a first end and a second end forming an interior volume. The second end includes a light assembly that encloses the second end and the first end is enclosed by a transparent lens. In this way, the receiver tube is leak proof and waterproof, which is beneficial for use near water. The light assembly includes a light source removably attached to a socket that provides electrical power to the light source. The socket is electrically connected to an on/off switch that provides electrical communication between a power source and the socket.

### CROSS REFERENCE TO RELATED APPLICATION

This application claims the benefit of U.S. Provisional Application No. 61/973,963 filed on Apr. 2, 2014. The above identified patent application is herein incorporated by reference in its entirety to provide continuity of disclosure.

### BACKGROUND OF THE INVENTION

### Field of the Invention

The present invention relates to lighting fixtures. More specifically, the present invention pertains to an improved pool light fixture that provides illumination near water or underwater. Some embodiments have been adapted for landscaping use.

Generally, cooling off by swimming during a summer day in a pool is a favorite pastime. However, some of these summer nights are also warm as well, and many people would enjoy taking a dip in the pool to cool off at night. However, the lack of illumination due to the night is usually a problem. Porch lights are usually brightly illuminated, which could wake up the neighborhood. Yet, swimming in the complete dark is also unreasonable because the risk of injury is too high. Therefore, there exists a need for a pool light that provides enough illumination to see during night, but without the brightness that may attract unhappy neighbors.

Conventional pool lights or in ground lighting options may be used to provide light, but such devices require a pool light niche to be affixed to a surface in the pool. Pool light niches are receptacles composed of a variety of materials, such as concrete, which are configured to receive and support a pool light therein. As a result, these types of lighting fixtures limit the scope of illumination and prevent portability. Therefore, there also exists a need for a pool light that is pivotable, and does not require a pool light niche to promote portability.

The present invention provides a pool light configured to provide illumination near water or underwater without the use a pool light niche. The pool light includes a base plate having mounted brackets thereon extending upwardly and perpendicularly therefrom. The mounted brackets are pivotally attached to a receiver tube, wherein the receiver tube is configured to pivot along a singular plane. The receiver tube includes a first end and a second end forming an interior volume. The first end includes a transparent lens and the interior volume on the second end includes a light assembly configured to direct light towards the transparent lens. The light assembly includes a light source, a socket used to provide electrical power to said light source, and an on/off switch configured to provide electrical communication between a power source and said socket. The transparent lens and the light assembly enclose said receiver tube, thereby allowing the receiver tube to be leak proof and waterproof.

### SUMMARY OF THE INVENTION

In view of the foregoing disadvantages inherent in the known types of pool lights now present in the prior art, the present invention provides a new and improved pool light wherein the same can be utilized for providing illumination around water or underwater.

It is therefore an object of the invention to provide a new and improved pool light that has all of the advantages of the prior art and none of the disadvantages.

Another object of the present invention is to provide a new and improved pool light comprising a base plate having mounting brackets thereon configured to pivotally attach a receiver tube.

Yet another object of the present invention is to provide a new and improved pool light, wherein said receiver tube includes a first end and a second end forming an interior volume configured to receive a light assembly.

A further object of the present invention is to provide a new and improved pool light, wherein said receiver tube is configured to be leak proof and waterproof, which allows said pool light to be used underwater or near water.

Another object of the present invention is to provide a new and improved pool light, wherein said light assembly includes a socket and a light source, wherein the socket is configured to provide electrical power to said light source.

Still yet another object of the present invention is to provide a new and improved pool light, wherein said light assembly further comprises an on/off switch configured to provide electric communication from a power source to the socket to provide electrical power to said light source.

Still yet another object of the present invention is to provide a new and improved pool light wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a front perspective view of the pool light of the present invention.

FIG. 2 shows a side view of the pool light of the present invention.

### DETAILED DESCRIPTION OF THE INVENTION

References are made herein to the attached drawings. Like reference numerals are used throughout the drawings to depict like or similar elements of the pool light. For the purposes of presenting a brief and clear description of the present invention, the preferred embodiment will be discussed as used for providing illumination around a pool or underwater. The figures are intended for representative purposes only and should not be considered to be limiting in any respect.

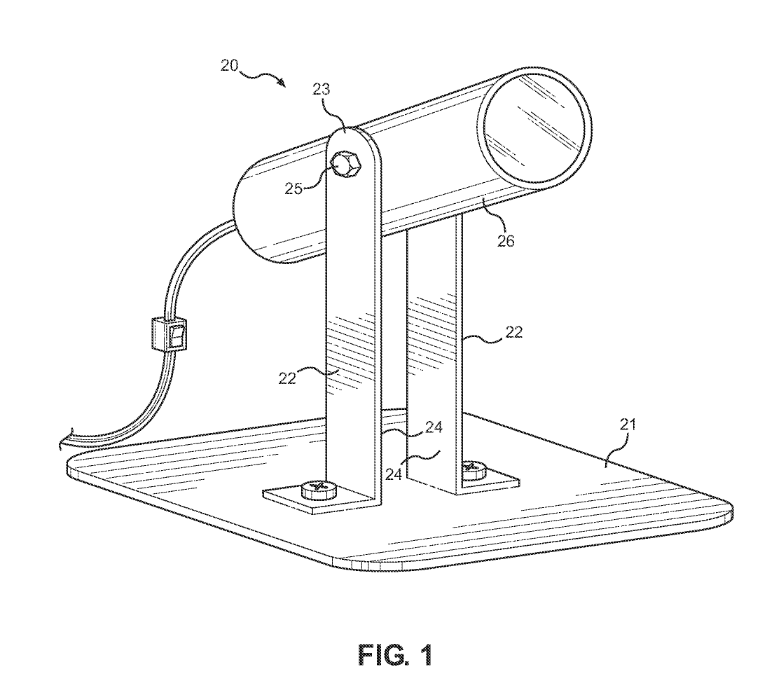

Referring now to FIG. 1, there is shown a front perspective of the pool light 20. The pool light 20 comprises a base plate 21 and at least one mounting bracket thereon. The base plate 21 is preferably a rectangular shape, however, other shapes and sizes are likewise contemplated. The illustrated embodiment includes a pair of mounting brackets 22 that extend upwardly and perpendicularly from the base plate 21. The pair of mounting brackets 22 are preferably centrally located and L-shaped, however, other shapes, locations, and sizes are suitable and likewise contemplated. For example, in another preferred embodiment, there includes a U-shaped mounting bracket extending upwardly from the base plate.

Preferably, the mounting brackets 22 and the base plate 21 are unitary in structure, however, in some embodiments, the mounting brackets 22 are removably fastened thereto via a fastener or other suitable means, such as adhesives. In these embodiments, the fastener is preferably a screw having threaded elements, wherein the base plate 21 further comprises aligning internal threaded elements. In addition, in some embodiments, the base plate 21 further includes fasteners that are configured to removably fasten said base plate 21 flush against a surface. The base plate 21 can be removably fastened to a horizontal surface, such as a pool deck, or a vertical surface, like a wall of a pool, via fasteners.

The mounting brackets 22 include a proximal end 23 and a distal end 24, wherein the distal end 24 is mounted on the base plate 21. The proximal end 24 of each mounting bracket 22 includes a fastener 25. The fastener 25 is configured to pivotally attach to a receiver tube 26 having a lighting assembly therein. The fastener 25 is also configured to allow the receiver tube 26 to pivot along a singular plane. This allows the lighting assembly to be directed towards a specific location, so that the user can adjust the direction of the light. Preferably the fastener includes a screw having threaded elements, wherein the receiver tube 26 includes aligning threaded elements. The light assembly is configured to provide illumination around a pool as well as underwater. In this way, the light assembly is particularly advantageous because it allows users to swim during nighttime. It is also contemplated that the pool light 20 can also be used as a wall mounted fixture, a landscape fixture, a directional fixture, a fountain fixture, a pond fixture and other suitable locations. Preferably, the pool light 20 is composed of thermoplastic or thermoset material, however, other waterproof, leak proof, noncorrosive material are likewise contemplated.

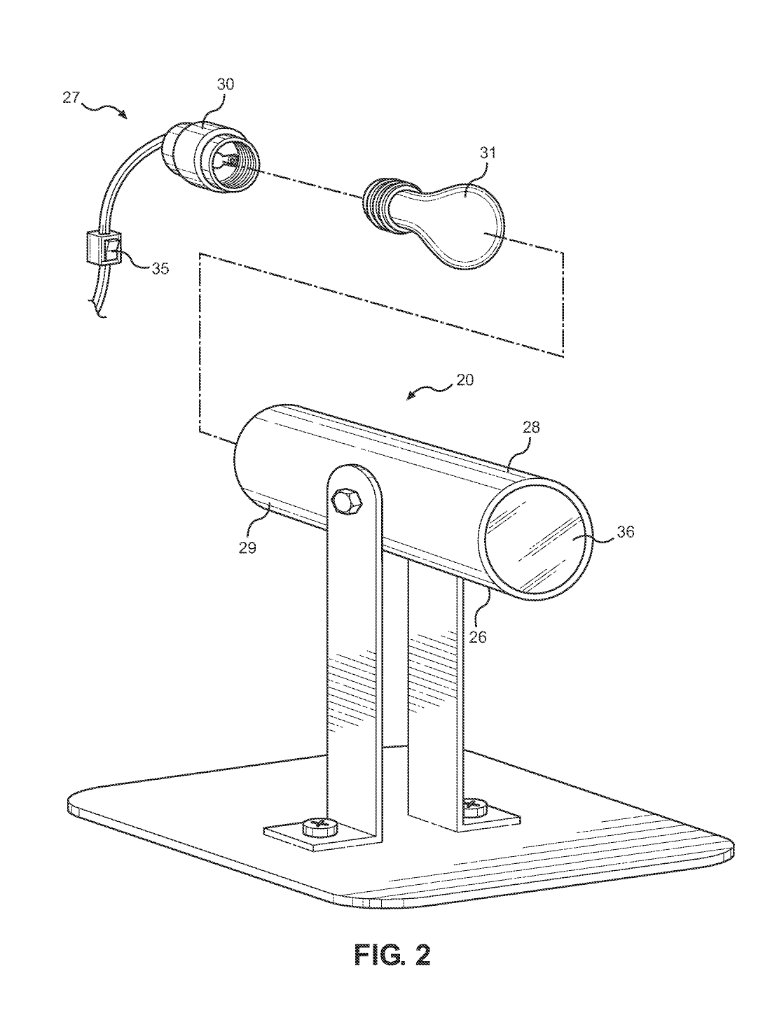

Referring now to FIG. 2, there is shown a side perspective of the pool light 20. The receiver tube 26 of the pool light 20 includes a first end 28 and a second end 29 forming an interior volume configured to support a lighting assembly 27 therein. The receiver tube 26 is preferably cylindrical, however, other shapes and sizes are likewise contemplated. In the illustrated embodiment, the light assembly 27 is located on the second end 29 and along the length of the receiver tube 26, wherein the light assembly 27 encloses said second end 29. In this way, the receiver tube 26 is configured to diffuse light emitted from the light assembly 27 towards the first end 28 of the receiver tube 26. The first end 28 of the receiver tube 26 includes a transparent lens 36 that is configured to not only guide light, but also to prevent water from leaking into the pool light 20. Thereby, the receiver tube 26 is constructed in a waterproof and leak proof manner, which is particularly advantageous for use around water.

The light assembly 27 includes a socket 30 and a light source 31 removably attached therein. In this way, the receiver tube 26 is particularly advantageous as it properly directs the light towards a dark area to aid in visibility. The socket 30 is preferably a cylindrical shape having a having a lower end and an upper end forming a hollow interior. The socket 30 is configured to provide an electric current to the light source 31 and to support the light source 31 within the second end 29 of the receiver tube 26. The socket 30 is internally threaded in order to receive a threaded base of the light source 31. As illustrated, the light source 31 is an incandescent bulb, however it is contemplated that embodiments of the pool light 20 include other suitable types of light sources, such as, but not limited to fluorescent lamps, compact fluorescent lamps, cold cathode fluorescent lamps, high intensity discharge lamps, and light emitting diode lamps.

As aforementioned, it is readily recognized that there are a variety of light sources 31 readily available in the art, wherein it is contemplated that in alternative embodiments of the pool light 20, the socket 30 includes corresponding fittings to receive a variety of light sources 31. It is expected that those of ordinary skill in the art will readily envision other preferable light sources 31 for the pool light 20, wherein these alterations and modifications are likewise contemplated within the scope and spirit of this present disclosure.

The socket 30 is electrically connected to a power source configured to supply the light source 31 with electrical power. The power source is preferably a wall outlet, however, other suitable means of electrical power are likewise contemplated. The light assembly 27 further comprises an on/off switch 35 that is configured to activate the light assembly 27 and provide electric communication between the light assembly 27 and the power source. The on/off switch 35 is disposed outside of the interior volume of the receiver tube 26, wherein the on/off switch 35 is easily accessible to a user. In the preferred embodiment, the on/off switch 35 is a rocker switch, however in alternative embodiments, the on/off switch 35 includes other suitable types of on/off switches, such as toggle switches or rotary switches.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A pool light, comprising:
a base plate having at least one mounting bracket thereon;
said at least one mounting bracket extending upwardly and perpendicularly therefrom;
a receiver tube pivotally secured to said at least one mounting bracket;
said receiver tube comprising a first end and a second end forming an interior volume;
wherein said first end comprises a transparent lens configured to enclose said first end;
a light assembly comprising a light source directed towards said first end of said receiver tube, wherein said light assembly is positioned in said interior volume of said second end;
wherein said light assembly encloses said second end;
wherein said receiver tube is configured to be leak proof and waterproof.

2) The pool light of claim 1, wherein:
said light assembly further comprises an on/off switch and a socket;
wherein said on/off switch configured to provide electric communication between said power source and said socket;
wherein said socket is electrically connected to a power source to provide electrical power for said light source.

3) The pool light of claim 2, wherein said socket is cylindrical and includes a hollow interior configured to removably receive and support said light source within said interior volume of said receiver tube.

4) The pool light of claim 1, wherein said receiving tube is adapted to pivot in a single plane.

5) The pool light of claim 1, wherein said at least one mounting bracket is substantially L-shaped.

6) The pool light of claim 1, wherein said at least one mounting bracket is centrally located on said base plate.

7) The pool light of claim 1, wherein said receiver tube is cylindrical in shape.

8) The pool light of claim 1, wherein said pair of mounting brackets further comprising fasteners configured to secure said pair of mounting brackets on said base plate.

9) The pool light of claim 1, wherein said base plate further comprising a plurality of fasteners configured to removably fasten said base plate flush against a surface.
